(19) United States
(12) Patent Application Publication
(10) Pub. No.: US 2026/0187556 A1
(43) Pub. Date: Jul. 2, 2026

(54) METHOD, SYSTEM, DEVICE, AND STORAGE MEDIUM FOR PUBLIC TRANSPORT SCHEDULING

(71) Applicant: Hon Hai Percision Industry Co., Ltd., New Taipei City (TW)

(72) Inventors: Chin Wei YANG, New Taipei City (TW); Hsiu Ching SU, New Taipei City (TW)

(73) Assignee: Hon Hai Percision Industry Co., Ltd., New Taipei City (TW)

(21) Appl. No.: 19/071,787

(22) Filed: Mar. 6, 2025

(30) Foreign Application Priority Data
Jan. 2, 2025 (CN) 2025100031050

(51) Int. Cl. G06Q 10/0631; G06Q 10/04; G06Q 50/40

(52) U.S. Cl. CPC G06Q 10/06315; G06Q 10/04; G06Q 50/40

(57) ABSTRACT

A method, system, device, and storage medium for public transport scheduling are provided. The method includes obtaining extensive traffic information; determining a target traffic scheduling model from a plurality of different traffic scheduling models in which the different traffic scheduling models are used to predict public transport scheduling information of different lengths of time; and inputting the extensive traffic information into the target traffic scheduling model to predict the public transport scheduling information of a corresponding length of time.

### RELATED APPLICATION(S)

This application claims the benefit of priority of China Patent Application No. 2025100031050 filed on Jan. 2, 2025, the contents of which are incorporated by reference as if fully set forth herein in their entirety.

### BACKGROUND OF INVENTION

### 1. Field of Invention

The present application relates to a technical field of Internet technologies, and particularly to a method, system, device, and storage medium for public transport scheduling.

### 2. Related Art

With the acceleration of urbanization and the increase in population density, urban public transport systems are facing unprecedented challenges. The growing passenger demand and ever worse traffic congestion have forced public transport scheduling systems to transform into a more efficient and flexible service model. However, current public transport scheduling systems lack a flexible prediction mechanism. When faced with various traffic conditions, it is often difficult to predict appropriate scheduling plans, making it impossible to effectively respond to various traffic conditions.

### SUMMARY OF INVENTION

The embodiments of the present application provide a method, system, device, and storage medium for public transport scheduling. The method for public transport scheduling can accurately predict applicable scheduling plans based on actual needs of various traffic conditions, thereby improving the flexibility and effectiveness of public transport scheduling.

In a first aspect, an embodiment of the present application provides a method for public transport scheduling, the method comprising:
obtaining extensive traffic information;
determining a target traffic scheduling model from a plurality of different traffic scheduling models, the different traffic scheduling models are used to predict public transport scheduling information of different lengths of time;
inputting the extensive traffic information into the target traffic scheduling model to predict the public transport scheduling information of a corresponding length of time.

In some embodiments, the traffic scheduling models comprise a short-term scheduling model, a medium-term scheduling model, and a long-term scheduling model. The short-term scheduling model is used to predict the public transport scheduling information within a first length of time, the medium-term scheduling model is used to predict the public transport scheduling information within a second length of time, and the long-term scheduling model is used to predict the public transport scheduling information within a third length of time. The first length of time is shorter than the second length of time, the second length of time is shorter than the third length of time, and the step of determining a target traffic scheduling model from a plurality of traffic scheduling models comprises:
determining a length of time for the public transport scheduling information to be predicted;
determining, in response to determining that the length of time does not exceed the first length of time, that the short-term scheduling model is the target traffic scheduling model;
determining, in response to determining that the length of time exceeds the first length of time but does not exceed the second length of time, that the medium-term scheduling model is the target traffic scheduling model;
determining, in response to determining that the length of time exceeds the second length of time but does not exceed the third length of time, that the long-term scheduling model is the target traffic scheduling model.

In some embodiments, in response to determining that the target traffic scheduling model is the short-term scheduling model, the inputting the extensive traffic information into the target traffic scheduling model to predict the public transport scheduling information of a corresponding length of time comprises:
obtaining first extensive traffic information corresponding to a fourth length of time; and
inputting the first extensive traffic information into the short-term scheduling model to predict first public transport scheduling information of the first length of time.

In some embodiments, in response to determining that the target traffic scheduling model is the medium-term scheduling model, the inputting the extensive traffic information into the target traffic scheduling model to predict the public transport scheduling information of a corresponding length of time comprises:
obtaining second extensive traffic information corresponding to a fifth length of time, and the fifth length of time is greater than the fourth length of time;
inputting the second extensive traffic information into the medium-term scheduling model to predict second public transport scheduling information of the second length of time; or
inputting the first public transport scheduling information and the second extensive traffic information into the medium-term scheduling model to predict the second public transport scheduling information of the second length of time.

In some embodiments, in response to determining that the target traffic scheduling model is the long-term scheduling model, the inputting the extensive traffic information into the target traffic scheduling model to predict the public transport scheduling information of a corresponding length of time comprises:
obtaining third extensive traffic information corresponding to a sixth length of time, and the sixth length of time is greater than the fifth length of time;
inputting the third extensive traffic information into the long-term scheduling model to predict third public transport scheduling information of the third length of time; or
inputting the second public transport scheduling information and the third extensive traffic information into the long-term scheduling model to predict the third public transport scheduling information of the third length of time.

In some embodiments, the extensive traffic information comprises real-time extensive traffic information and historical extensive traffic information, and the determining a length of time for the public transport scheduling information to be predicted comprises:
analyzing the real-time extensive traffic information and the historical extensive traffic information to identify fluctuation characteristics of the extensive traffic information. The fluctuation characteristics include at least one of temporary fluctuation changes, periodic changes, and long-term trends; and
determining the length of time for the public transport scheduling information to be predicted according to a duration of the impact of the fluctuation characteristics on the public transport.

In some embodiments, prior to the determining a target traffic scheduling model from a plurality of different traffic scheduling models, the method further comprises:
collecting historical extensive traffic information of different lengths of time; and
obtaining, using the historical extensive traffic information of each of the lengths of time to perform machine learning, a traffic scheduling model corresponding to each of the lengths of time.

In some embodiments, the obtaining, using the historical extensive traffic information of each of the lengths of time to perform machine learning, a traffic scheduling model corresponding to each of the lengths of time comprises:
dividing the historical extensive traffic information of each of the lengths of time into a training dataset, a validation dataset, and a test dataset according to a preset ratio;
building, using the training dataset to perform machine learning, an initial traffic scheduling model corresponding to the length of time;
optimizing, using the validation dataset to perform a performance evaluation on the initial traffic scheduling model and adjusting parameters of the initial traffic scheduling model according to results of the performance evaluation, the initial traffic scheduling model; and
evaluating, using the test dataset, generalization performance of the optimized initial traffic scheduling model, and obtaining, in response to that the generalization performance of the optimized initial traffic scheduling model reaches a preset generalization capability requirement, the traffic scheduling model corresponding to the length of time.

In some embodiments, the inputting the extensive traffic information into the target traffic scheduling model to predict the public transport scheduling information of a corresponding length of time comprises:
filtering relevant traffic information affecting public transport from the extensive traffic information;
cleaning and standardizing the relevant traffic information;
performing dimensionality reduction processing on the relevant traffic information being cleaned and standardized;
extracting, using at least one of time series analysis, signal processing technology, and feature engineering to perform feature extraction on the relevant traffic information after the dimensionality reduction processing, derived traffic information; and
predicting, by inputting the derived traffic information into the target traffic scheduling model, the public transport scheduling information of a corresponding length of time.

In a second aspect, an embodiment of the present application provides a system for public transport scheduling, the system comprising:
an electronic device obtaining extensive traffic information and comprising a mobile terminal and an Internet of Things (IoT) device; and
a server connected to the Internet of Things device and the mobile terminal and configured to execute any of the methods described above.

In a third aspect, an embodiment of the present application provides a public transport scheduling device, the device comprising:
an obtaining module configured to obtain extensive traffic information;
a determination module configured to determine a target traffic scheduling model from a plurality of different traffic scheduling models, and the different traffic scheduling models are used to predict public transport scheduling information of different lengths of time; and
a prediction module configured to input the extensive traffic information into the target traffic scheduling model to predict the public transport scheduling information of a corresponding length of time.

In a fourth aspect, an embodiment of the present application provides a storage medium storing a computer program, and when the computer program is run on a computer, the computer is enabled to execute any one of the methods described above.

In the embodiment of the present application, a variety of traffic scheduling models are preset. Different traffic scheduling models can predict public transport scheduling information of different lengths of time. Therefore, when faced with different prediction needs, a most suitable traffic scheduling model can be selected from a plurality of traffic scheduling models as the target scheduling model. For example, when dealing with sudden temporary traffic congestions, a traffic scheduling model that focuses on predicting shorter lengths of time can be selected. Based on the extensive traffic information collected, public transport scheduling information can be quickly outputted for the next few minutes to hours, thereby providing immediate and effective vehicle scheduling solutions, rapidly alleviating passenger flow pressure, and solving current emergency problems. As another example, when it is necessary to plan urban traffic from a longer-term perspective, a traffic scheduling model that focuses on predicting longer lengths of time can be selected. Based on the extensive traffic information collected, public transport scheduling information, for example, for the next few months to years can be predicted, thereby helping to better formulate longer-term vehicle scheduling, route adjustments, and other strategies to meet the long-term optimization needs of public transport. Therefore, when dealing with various traffic conditions and their different prediction needs, in the present embodiments, a suitable target scheduling model from multiple traffic scheduling models can be flexibly selected to predict public transport scheduling information with strong pertinence and high accuracy. Whether it is to deal with sudden immediate traffic problems or to carry out longer-term planning needs, it can be effectively solved, thereby greatly improving the flexibility and effectiveness of public transport scheduling.

### BRIEF DESCRIPTION OF DRAWINGS

In order to more clearly illustrate the technical solutions in the embodiments of the present application, the drawings required for use in the description of the embodiments will be briefly introduced below. Obviously, the drawings described below are only some embodiments of the present application. For those skilled in the art, other drawings can be obtained based on these drawings without creative work.

FIG. 1 is a schematic diagram of a flowchart of a method for public transport scheduling provided in an embodiment of the present application;

FIG. 2 is another schematic diagram of a flowchart of a method for public transport scheduling provided in an embodiment of the present application;

FIG. 3 is a flowchart of a traffic scheduling model training process provided in an embodiment of the present application;

FIG. 4 is another schematic diagram of a flowchart of a traffic scheduling model training process provided in an embodiment of the present application;

FIG. 5 is a schematic diagram of a process for extracting derived traffic features from extensive traffic information provided in an embodiment of the present application;

FIG. 6 is a schematic structural diagram of a system for public transport scheduling provided in an embodiment of the present application;

FIG. 7 is a schematic diagram of a scenario of the operation of a system for public transport scheduling provided in an embodiment of the present application;

FIG. 8 is a schematic diagram of another scenario of the operation of a system for public transport scheduling provided in an embodiment of the present application;

FIG. 9 is a schematic structural diagram of a device for public transport scheduling provided in an embodiment of the present application;

FIG. 10 is another schematic structural diagram of a device for public transport scheduling provided in an embodiment of the present application.

### DESCRIPTION OF PREFERRED EMBODIMENTS

The technical solutions in the embodiments of the present application will be clearly and completely described below in conjunction with the drawings in the embodiments of the present application. Obviously, the described embodiments are only part of the embodiments of the present application, rather than all the embodiments. Based on the embodiments in this application, all other embodiments obtained by those skilled in the art without making any creative work shall fall within the scope of protection of this application.

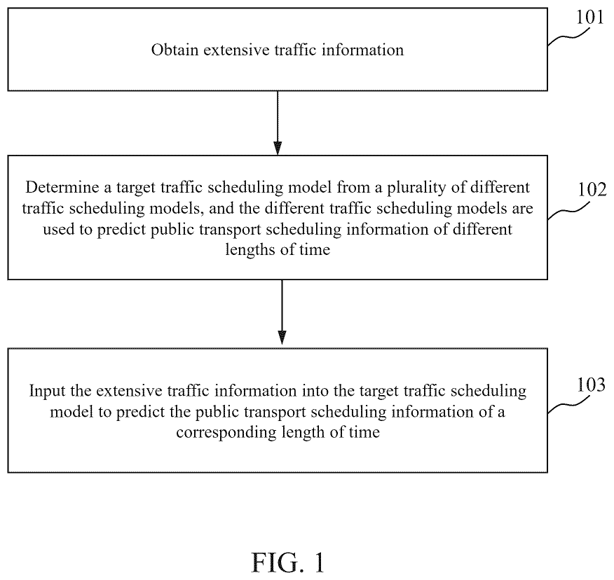

Please refer to FIG. 1, which is a flowchart of a method for public transport scheduling according to an embodiment of the present application. The specific process of the method for the public transport scheduling can be as follows:

In 101, obtain extensive traffic information;

In 102, determine a target traffic scheduling model from a plurality of different traffic scheduling models, and the different traffic scheduling models are used to predict public transport scheduling information of different lengths of time;

In 103, input the extensive traffic information into the target traffic scheduling model to predict the public transport scheduling information of a corresponding length of time.

This embodiment can obtain extensive traffic information. For example, the extensive traffic information may include vehicle information, passenger information, environmental information, time information, event information, and other multi-dimensional information, providing extensive and rich data support for the traffic scheduling model to predict public transport scheduling information, thereby improving the accuracy of the prediction. Specifically, vehicle information includes, for example, real-time location of vehicles, driving speed, passenger status, whether the vehicle is in normal operation or broken down, routes of the vehicle, etc.; passenger information includes, for example, statistics on number of passengers boarding and alighting the vehicle at each station, waiting time of passengers at the station, frequency of riding, starting stations of passengers, destination stations, expected riding time, and riding demands of special groups, such as the elderly, the disabled, and pregnant women; environmental information includes, for example, weather conditions, air quality, road conditions, road congestion, road construction, etc.; time information includes, for example, specific time points, such as date, week, length of time, and time characteristic information, such as whether it is a holiday, weekday, or weekend; event information includes, for example, arrangements for large-scale events, such as concerts and sports events, traffic control measures, traffic accidents, natural disasters, etc. The present application does not specifically limit the content of the extensive traffic information, and more multi-dimensional information that may affect the operation of public transport can be obtained as needed. It should be noted that the extensive traffic information may include real-time extensive traffic information, and may also include extensive traffic information over a period of history.

This embodiment can adopt a plurality of methods to obtain extensive traffic information. For example, IoT devices can be deployed in public transport vehicles and their stops. These IoT devices can instantly capture rich data, including the vehicle's real-time location, driving speed, passenger status, and passenger behavior data such as the waiting conditions of passengers at each stop. The IoT devices can timely transmit collected data to a server. Passengers can also conveniently enter their personal travel requirements, such as the starting point, destination, and expected travel time, through the application on their mobile terminals. This information will also be uploaded to the server through the application for processing and analysis. Specifically, the server may include a cloud server and/or a local server, which is not limited in this embodiment. In addition, the server can also integrate application programming interface (API) technology to obtain current weather conditions in real time, including temperature, rainfall, wind speed, and other environmental data, to provide meteorological reference for traffic scheduling. In terms of time dimensions, a precise time point of each data collection can be recorded, covering time characteristics, such as date, week, length of time, and whether it is a holiday, providing a solid foundation for the time series analysis of traffic information. In addition, it further allows to obtain information about important events such as large-scale event arrangements, traffic control measures, government policies, etc. through direct feedback from passengers or by regularly collecting information from authoritative media and official websites, all of which have a direct or indirect impact on traffic scheduling. This embodiment can collect multi-dimensional extensive traffic information in real time through a series of information collection means.

In this embodiment, a variety of traffic scheduling models are preset. Different traffic scheduling models can predict public transport scheduling information of different lengths of time. Therefore, when faced with different prediction needs, a most suitable traffic scheduling model can be selected from a plurality of traffic scheduling models as the target scheduling model. For example, when dealing with sudden temporary traffic congestions, a traffic scheduling model that focuses on predicting shorter lengths of time can be selected. Based on the extensive traffic information collected, public transport scheduling information can be quickly outputted for the next few minutes to hours, thereby providing immediate and effective vehicle scheduling solutions, rapidly alleviating passenger flow pressure, and solving current emergency problems. As another example, when it is necessary to plan urban traffic from a longer-term perspective, a traffic scheduling model that focuses on predicting longer lengths of time can be selected. Based on the extensive traffic information collected, public transport scheduling information, for example, for the next few months to years can be predicted, thereby helping to better formulate longer-term vehicle scheduling, route adjustments, and other strategies to meet the long-term optimization needs of public transport. Therefore, the present application not only improves the accuracy of prediction by completely obtaining extensive traffic information, but also ensures that when dealing with various traffic conditions and their different prediction needs, a suitable target scheduling model from multiple traffic scheduling models can be flexibly selected to predict public transport scheduling information with strong pertinence and high accuracy. Whether it is to deal with sudden immediate traffic problems or to carry out longer-term planning needs, it can be effectively solved, thereby greatly improving the flexibility and effectiveness of public transport scheduling.

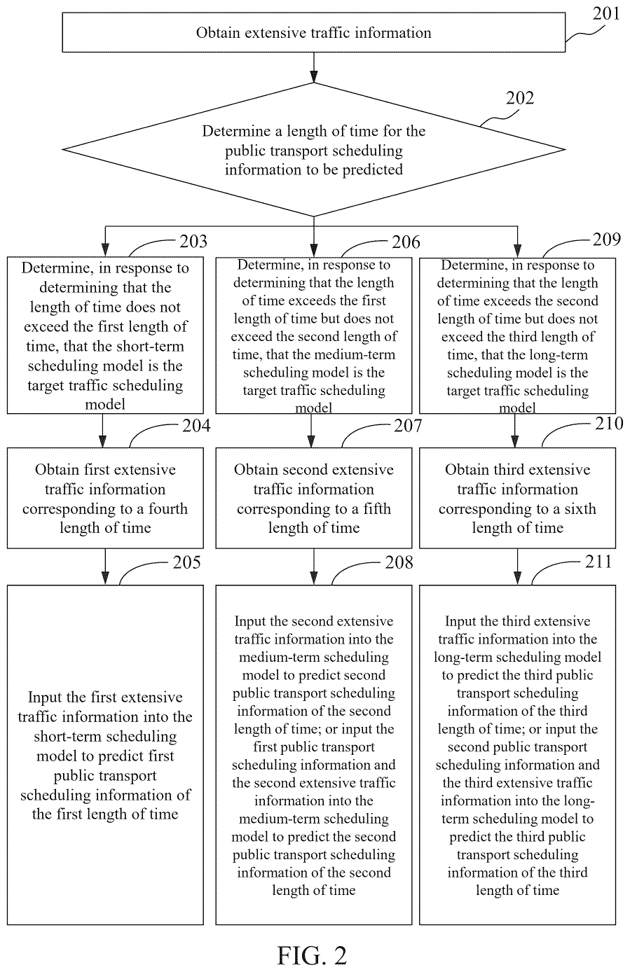

Please refer to FIG. 2, which is another schematic diagram of a flowchart of a method for public transport scheduling provided in an embodiment of the present application. Specific processes of the method for the public transport scheduling can be as follows:

In 201, obtain extensive traffic information;

The method of the embodiment can obtain extensive traffic information, which includes multiple dimensions of information such as vehicle information, passenger information, environmental information, time information, event information, etc., providing extensive and rich data support for the traffic scheduling model to predict public transport scheduling information, thereby improving the accuracy of the prediction. It should be noted that the extensive traffic information may include real-time extensive traffic information, and may also include extensive traffic information over a period of history. The method for obtaining the extensive traffic information has been described above and will not be repeated here.

In 202, determine a length of time for the public transport scheduling information to be predicted;

In some embodiments, the traffic scheduling models may include a short-term scheduling model, a medium-term scheduling model and a long-term scheduling model. The short-term scheduling model is used to predict public transport scheduling information of a first length of time, the medium-term scheduling model is used to predict public transport scheduling information of a second length of time, and the long-term scheduling model is used to predict public transport scheduling information of a third length of time. Specifically, the first length of time is shorter than the second length of time, and the second length of time is shorter than the third length of time. Specifically, the first length of time, the second length of time, and the third length of time can be adjusted as needed, and are not limited in this embodiment. For example, the short-term scheduling model can be used to predict public transport scheduling information in the next few minutes to hours, the medium-term scheduling model can be used to predict public transport scheduling information in the next few days to weeks, and the long-term scheduling model can be used to predict public transport scheduling information in the next few months to years.

For example, the length of time of the public transport scheduling information to be predicted may be determined based on the duration of traffic conditions to be improved. For example, when a large-scale concert is held temporarily, the concert may last for several hours, and public transport scheduling information for the next few hours needs to be predicted immediately, so the length of time can be several hours. As another example, when traffic flow or passenger flow changes during holidays or weekends, it is necessary to predict public transport scheduling information for holidays or weekends, and the length of time can be 1 day to 2 weeks. As another example, when the traffic flow or passenger flow changes seasonally, public transport scheduling information for the following season needs to be predicted, and the length of time can be several months.

As another example, the length of time of the public transport scheduling information to be predicted can be automatically determined based on the extensive traffic information. Specifically, the extensive traffic information includes real-time extensive traffic information and historical extensive traffic information. The real-time extensive traffic information and the historical extensive traffic information are analyzed to identify fluctuation characteristics of the extensive traffic information. The fluctuation characteristics include: at least one of temporary fluctuation changes, periodic changes, and long-term trends; according to the length of time that the fluctuation characteristics affect public transport, the length of time of the public transport scheduling information to be predicted is determined.

By analyzing the real-time extensive traffic information and the historical extensive traffic information, the fluctuation characteristics of the extensive traffic information can be identified. If the fluctuation feature is identified as a temporary fluctuation change, the temporary fluctuation change may be a short-term, non-periodic change in the traffic flow and/or passenger flow caused by emergencies including traffic accidents, severe weather conditions (such as heavy rain), large-scale events (such as concerts), etc. This temporary fluctuation is sudden and short-lived, and its impact is usually short-lived, perhaps only in the next few hours. In this case, it can be considered that the length of time of the public transport scheduling to be predicted is several hours. If the fluctuation characteristics are identified as periodic changes, the periodic changes are changes in the traffic flow and/or passenger flow that occur repeatedly within a specific length of time. This periodic change reflects the regularity of people's daily travel habits, and the duration of its impact can be determined based on the length of the specific length of time. For example, during the morning and evening peak periods on weekdays, there is usually a significant increase in the traffic flow and/or passenger flow, and the duration of the impact is usually several hours. Then it can be considered that the length of time of the public transport scheduling to be predicted is, for example, a few hours; the traffic flow and/or passenger flow on weekends may be different from that on weekdays, and the length of time of the impact may be, for example, one to two days, then it can be considered that the length of time of the public transport scheduling to be predicted is, for example, one to two days; as another example, the traffic flow and/or passenger flow during winter and summer vacations will also change from that on weekdays, and the length of time of the impact can be, for example, January to February. Then it can be considered that the length of time of the public transport scheduling to be predicted is, for example, January to February. If the fluctuation characteristics are identified as long-term trends, which reflect the development trend or constant change direction of traffic flow and/or passenger flow, and whose impact lasts for a longer period of time, then it can be considered that the length of time of the public transport scheduling to be predicted is, for example, the next few months to several years.

It should be noted that the traffic scheduling model in this embodiment is not limited to the division of the short-term scheduling model, the medium-term scheduling model, and the long-term scheduling model, but can also be classified in many other ways according to the length of time. For example, the traffic scheduling model can also be divided into: an instant traffic scheduling model (quick response to instant traffic changes), a daily traffic scheduling model (considering traffic flow changes at different times of the day), a weekly traffic scheduling model (planning based on the difference between working days and rest days in a week), a monthly traffic scheduling model (considering seasonal changes or monthly activity arrangements) or an annual traffic scheduling model (long-term planning for annual holidays, large-scale events, etc.), and other models.

In 203, determine, in response to determining that the length of time does not exceed the first length of time, that the short-term scheduling model is the target traffic scheduling model;

In 204, obtain first extensive traffic information corresponding to a fourth length of time;

In 205, input the first extensive traffic information into the short-term scheduling model to predict first public transport scheduling information of the first length of time.

After determining the length of time of the public transport scheduling information to be predicted, further determine an interval to which the length of time belongs. If the length of time does not exceed the first length of time that can be predicted by the short-term scheduling model, determine that the short-term scheduling model is the target traffic scheduling model to respond to immediate traffic scheduling needs. Specifically, the first length of time may be, for example, a few minutes to a few hours in the future.

Obtain the first extensive traffic information corresponding to the fourth length of time. Specifically, the first extensive traffic information corresponding to the fourth length of time may be current real-time extensive traffic information, or the fourth length of time may be equal to or close to the first length of time, and may include the current real-time extensive traffic information and historical extensive traffic information close to the current time, such as extensive traffic information in the recent few minutes to several hours. Specifically, the historical extensive traffic information can be extracted from a historical database.

The first extensive traffic information is input into the short-term scheduling model to predict the first public transport scheduling information of the first length of time in the future, so that a traffic management department can schedule the public transport according to the first public transport scheduling information. For example, the duration of the morning rush hour is from 7:00 to 9:00. Therefore, vehicle and passenger information, such as the current real-time vehicle position, driving speed, passenger status, number of passengers boarding and alighting, and passenger waiting time can be collected and input into the short-term scheduling model to predict public transport scheduling information for the next two hours to meet the challenges during the morning rush hour. For example, at bus stops or subway stations with heavy passenger flow, the number of vehicles deployed can be increased and vehicle operating intervals can be adjusted to shorten passenger waiting time. It should be noted that the traffic management department can coordinate the scheduling of multiple public transport modes, such as buses, subways, taxis, shared cars, ferries, etc.

In 206, determine, in response to determining that the length of time exceeds the first length of time but does not exceed the second length of time, that the medium-term scheduling model is the target traffic scheduling model;

In 207, obtain second extensive traffic information corresponding to a fifth length of time;

In 208, input the second extensive traffic information into the medium-term scheduling model to predict second public transport scheduling information of the second length of time; or input the first public transport scheduling information and the second extensive traffic information into the medium-term scheduling model to predict the second public transport scheduling information of the second length of time.

When it is determined that the length of time of the public transport scheduling information to be predicted exceeds the first length of time but does not exceed the second length of time, the medium-term scheduling model is determined as the target traffic scheduling model. For example, if the time required for prediction is from a few days to a few weeks, then the medium-term scheduling model is the most appropriate choice to ensure the accuracy and practicality of the prediction.

Obtain the second extensive traffic information corresponding to the fifth length of time. Specifically, the fifth length of time is greater than the fourth length of time, and may be equal to or close to the second length of time, such as including extensive traffic information over the past few days to weeks, so as to provide sufficient information to support the medium-term scheduling model to predict the public transport scheduling information for the next second length of time.

Exemplarily, the second extensive traffic information may be directly input into the medium-term scheduling model to predict the second public transport scheduling information for the next second length of time.

As another example, in order to improve the accuracy of the prediction, the prediction result of the short-term scheduling model, i.e., the first public transport scheduling information, can be input into the medium-term scheduling model together with the second extensive traffic information to predict the second public transport scheduling information of the second length of time. This allows for comprehensive consideration of short-term and medium-term traffic changes, as well as their mutual impact, leading to more accurate and reliable forecast results.

For example, a large-scale sports event is expected to be held in the next two weeks. This sports event is expected to attract a large number of spectators to watch the game. It is decided to use a medium-term scheduling model to predict public transport scheduling information for the next two weeks. In this case, it is necessary to collect extensive traffic information from the past few days to weeks. This information includes vehicle information and passenger information, such as vehicle location, driving speed, passenger status, number of passengers boarding and alighting, passenger waiting time, as well as environmental information, such as weather conditions, road conditions, and traffic control measures. In addition, it is also necessary to collect event information, such as the specific time, location, and expected number of spectators of the sports meeting. After collecting enough extensive traffic information, the second extensive traffic information is input into the medium-term scheduling model. Alternatively, the prediction results of the short-term scheduling model (i.e., the public transport scheduling information in the next few days) are input into the medium-term scheduling model together with the second extensive traffic information to predict the public transport scheduling information in different lengths of time and regions in the next two weeks. Vehicle deployment, route layout, etc. are adjusted according to the public transport scheduling information to ensure that public transport services during the sports can meet the needs of spectators and participants.

In 209, determine, in response to determining that the length of time exceeds the second length of time but does not exceed the third length of time, that the long-term scheduling model is the target traffic scheduling model.

In 210, obtain third extensive traffic information corresponding to a sixth length of time;

In 211, input the third extensive traffic information into the long-term scheduling model to predict the third public transport scheduling information of the third length of time; or input the second public transport scheduling information and the third extensive traffic information into the long-term scheduling model to predict the third public transport scheduling information of the third length of time.

When it is determined that the length of time of the public transport scheduling information to be predicted exceeds the second length of time but does not exceed the third length of time, the long-term scheduling model is determined as the target traffic scheduling model. For example, if the time required for prediction is from several months to several years, then the long-term scheduling model is the most appropriate choice to ensure the accuracy and practicality of the prediction.

Obtain the third extensive traffic information corresponding to the sixth length of time. Specifically, the sixth length of time is greater than the fifth length of time, and the sixth length of time may be equal to or close to the third length of time, such as including extensive traffic information over the past few months to several years, so as to provide sufficient information to support the long-term scheduling model to predict the third public transport scheduling information for the next third length of time.

Exemplarily, the third extensive traffic information may be directly input into the long-term scheduling model to predict the third public transport scheduling information within the third length of time.

As another example, in order to improve the accuracy of the prediction, the prediction result of the medium-term scheduling model, that is, the second public transport scheduling information, can be input into the long-term scheduling model together with the third extensive traffic information so that the long-term scheduling model can make accurate predictions.

For example, the construction of a new shopping mall will affect the traffic flow around the new shopping mall in the next few years. This length of time exceeds the prediction range of the medium-term scheduling model (a few days to a few weeks), but does not exceed the prediction range of the long-term scheduling model (a few months to a few years). Therefore, it is determined to use the long-term scheduling model to predict and plan future public transport services. Collect the third extensive traffic information of the sixth length of time in the past, such as the past few years. This information not only covers vehicle information and passenger information such as vehicle location, driving speed, passenger status, number of passengers boarding and alighting, passenger waiting time, etc., but also can collect event information related to the construction of the new shopping mall, such as the construction time, location, expected scale, business distribution, and other information of the shopping mall. The rich and extensive traffic information will provide a solid foundation for the long-term scheduling model, helping to predict public transport scheduling information in the next few years after the new shopping mall is built. For example, new public transport routes can be planned, existing public transport stops can be adjusted, the frequency of existing routes can be increased to cope with the increased passenger flow, or the operating hours of public transport can be adjusted to match the operating hours of the shopping mall, etc., to meet long-term traffic needs and provide people with convenient public transport services.

It should be noted that there is a correlation between the first public transport scheduling information generated by the short-term scheduling model, the second public transport scheduling information generated by the medium-term scheduling model, and the third public transport scheduling information generated by the long-term scheduling model. Through a step-by-step approach, that is, using the results of the short-term scheduling model prediction as input features of the medium-term scheduling model, and then using the results of the medium-term scheduling model prediction as input features of the long-term scheduling model prediction, the results of the short-term scheduling model prediction usually focus on current and recent changes. Using this information as the input features of the medium-term scheduling model can help the medium-term scheduling model better understand and predict traffic trends in the next few days to weeks. Similarly, the prediction results of the medium-term scheduling model can further provide valuable information for the long-term prediction, thereby building a more coherent and accurate prediction system.

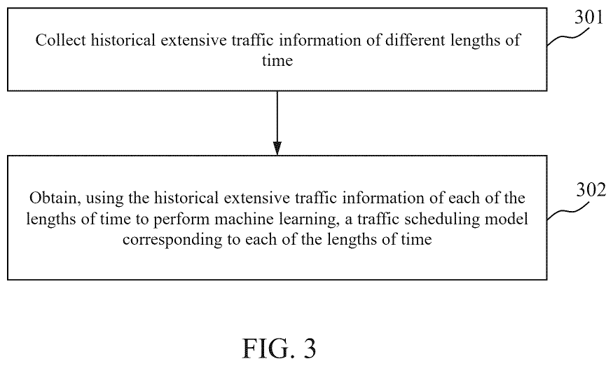

In some embodiments, different traffic scheduling models are selected to predict effective public transport scheduling information according to the characteristics of different traffic conditions. Therefore, before determining a target model from multiple traffic scheduling models based on real-time extensive traffic information, these traffic scheduling models need to be trained in advance. For example, please refer to FIG. 3, which is a flowchart of a traffic scheduling model training process provided in an embodiment of the present application. The specific process can be as follows:

In 301, collect historical extensive traffic information of different lengths of time.

In order to train a model that can predict public transport scheduling information of different lengths of time, it is necessary to collect the historical extensive traffic information of multiple different lengths of time. This information not only covers basic vehicle information (such as vehicle location, speed, operating status, etc.), passenger information (such as the number of passenger boarding and alighting, passenger density, etc.), but also deeply touches on environmental information (such as weather conditions, road conditions, traffic control measures, etc.), time information (such as date, length of time, holidays, etc.) and various types of event information (such as special events, traffic accidents, road construction, etc.).

Given that different traffic scheduling models are responsible for predicting traffic scheduling tasks for different time spans, for example, different traffic scheduling models include a short-term scheduling model, a medium-term scheduling model, and a long-term scheduling model. The short-term scheduling model is used to predict public transport scheduling information in the next few minutes to hours, the medium-term scheduling model is used to predict public transport scheduling information in the next few days to weeks, and the long-term scheduling model is used to predict public transport scheduling information in the next few months to years. In order to ensure that the traffic scheduling model can accurately predict public transport scheduling information of various lengths of time, historical extensive traffic information that matches a predicted target length of time is also selected during the training process as training data for a machine learning model.

It should be noted that the short-term scheduling model, the medium-term scheduling model, and the long-term scheduling model focus on different lengths of time and prediction targets, and may focus on different extensive traffic information. Therefore, during training or prediction, the same or different types of information in the extensive traffic information can be used for training or prediction according to actual conditions, which are not limited in this embodiment. For example, the short-term scheduling model may focus more on specific traffic events, such as temporary traffic control, vehicle failures, etc. The medium-term scheduling model may focus more on information such as holidays and large-scale events. The long-term scheduling model may focus more on government-issued traffic policies, such as the impact of other modes of transportation such as shared bicycles on public transport.

In 302, obtain, using the historical extensive traffic information of each of the lengths of time to perform machine learning, a traffic scheduling model corresponding to each of the lengths of time.

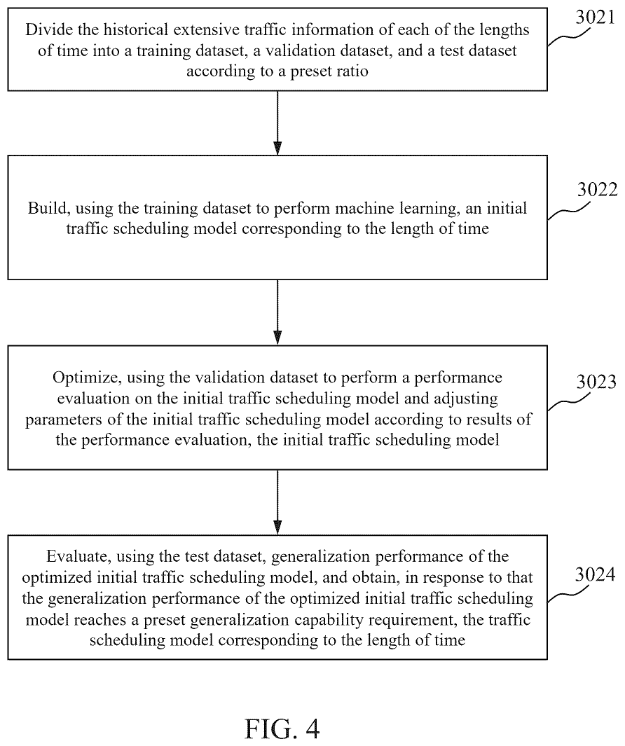

Please refer to FIG. 4, which is another schematic diagram of a flowchart of a traffic scheduling model training process provided in an embodiment of the present application; Specifically, step 302 may include:

In 3021, divide the historical extensive traffic information of each of the lengths of time into a training dataset, a validation dataset, and a test dataset according to a preset ratio.

In order to ensure that the trained traffic scheduling model can perform well on unseen data, when training a specific traffic scheduling model, the historical extensive traffic information of a corresponding length of time can be divided into the training dataset, the validation dataset, and the test dataset according to the preset ratio. This embodiment does not limit the preset ratio, and the preset ratio can be, for example, 8:1:1. This division can be achieved through random sampling or time series segmentation. Specifically, the training dataset is used to train the model, the validation dataset is used for model tuning, and the test dataset is used to finally evaluate the generalization ability of the model.

In 3022, build, using the training dataset to perform machine learning, an initial traffic scheduling model corresponding to the length of time.

After preparing the training dataset, a suitable machine learning model needs to be selected to learn the training dataset to build the initial traffic scheduling model. Machine learning models can include linear regression, decision tree, random forest, support vector machine, and neural network, etc. The same machine learning model can be selected to train different traffic scheduling models, or choosing different machine learning models to train different traffic scheduling models based on the characteristics and advantages of different machine learning models to achieve the best prediction effect. For example, machine learning models such as neural networks or random forests are good at handling nonlinear relationships and complex patterns in time series data, and are suitable for predicting traffic flow in the next few hours. Therefore, they are suitable for training short-term traffic scheduling models. Support vector machines (SVM) or random forests perform well in dealing with medium-term trends and periodic changes, and are suitable for predicting traffic demand in the next few days to weeks. Therefore, they are suitable for training medium-term traffic scheduling models. Linear regression or time series models (such as ARIMA) are more stable and accurate in predicting long-term trends and seasonal changes. They are suitable for predicting traffic demand in the next few months to years, and are therefore suitable for training long-term traffic scheduling models.

After selecting a machine learning model, model building can be performed before training to provide the necessary foundation and framework for model training. The model building can include feature selection, model initialization, loss function setting, optimization algorithm selection, etc. The feature selection is used to determine which features will be used to train the model, which helps the machine learning model capture the most important information in the data; the model initialization is used to set initial parameters of the machine learning model, which will be adjusted during the training process. The parameters may include weights, biases, etc.; the loss function setting is used to define a loss function to measure the accuracy of model predictions. The goal of training is to minimize the loss. The loss function may include mean square error (MSE), cross entropy, etc.; the optimization algorithm selection is used to select an algorithm to update model parameters to reduce a value of the loss function. Optimization algorithms may include gradient descent, stochastic gradient descent, Adam, etc.

After the model is built, the machine learning model is trained using the training dataset to minimize the loss function. The training process includes: forward propagation, loss calculation, back propagation, iterative training, etc. The forward propagation includes inputting the training dataset and calculating a predicted value through a model; the loss calculation includes calculating the error between the predicted value and a true value according to a loss function; the back propagation includes calculating the gradient according to the error through the chain rule and updating the model parameters; the iterative training includes repeating the forward propagation and the back propagation processes until the loss function converges or reaches a predetermined number of training rounds.

In 3023, optimize, using the validation dataset to perform a performance evaluation on the initial traffic scheduling model and adjusting parameters of the initial traffic scheduling model according to results of the performance evaluation, the initial traffic scheduling model.

The validation dataset is a dataset independent of the training dataset and is used to monitor the performance of the model during model training and to help adjust model parameters. Apply the trained model to the validation dataset and calculate the difference between the model's predictions and the actual results. Commonly used evaluation metrics include root mean square error (RMSE), mean absolute error (MAE), and coefficient of determination (R²). Based on results of the evaluation metrics, analyze the performance of the model. If the model does not perform well on the validation dataset, the model parameters, etc., may need to be adjusted.

In addition, the validation dataset can be used to evaluate the model performance under different hyperparameter settings. By comparing the performance of different hyperparameter combinations on the validation dataset, an optimal hyperparameter combination can be selected to improve the accuracy and generalization ability of the model. Hyperparameters may include learning rate, regularization parameters, model complexity, etc. Hyperparameter tuning methods may include grid search, random search, etc. Moreover, cross-validation can be used to accurately evaluate the generalization ability of the model and help determine whether the model is overfitting or underfitting. The three steps of validation dataset evaluation, hyperparameter tuning, and cross-validation can work together to ensure high performance and good generalization ability of the model.

In 3024, evaluate, using the test dataset, generalization performance of the optimized initial traffic scheduling model, and obtain, in response to that the generalization performance of the optimized initial traffic scheduling model reaches a preset generalization capability requirement, the traffic scheduling model corresponding to the length of time.

The test dataset is a dataset independent of the training dataset and the validation dataset. It simulates the data that the trained model will encounter in actual applications. The purpose of evaluating the test dataset is to verify the performance of the model on completely unseen data, that is, the generalization ability of the model. A model with good generalization ability can make accurate predictions on unseen data. The optimized model can be re-evaluated using the test dataset. Common evaluation metrics include accuracy, recall, F1 score, root mean square error (RMSE), mean absolute error (MAE), etc.

Apply the optimized model to the test dataset, analyze the performance of the model on the test dataset, and determine whether the model meets the preset generalization performance requirements. If the generalization performance of the model meets the preset requirements, the model is considered effective and can be used for actual traffic scheduling; if it does not meet the requirements, it may be necessary to return to the model training and tuning stage to further optimize the model. Evaluation results of the test dataset provide a decision-making basis for the final deployment of the model, ensuring the practicality and effectiveness of the model.

Through the evaluation of the test dataset, when it is confirmed that the generalization performance of the model meets the preset requirements, the trained model can be deployed to the actual public transport scheduling system. When the generalization performance of multiple models meets the preset requirements, the best model can be selected according to performance indicators of the model and determined as the traffic scheduling model for deployment. Public transport scheduling information prediction and decision support can be achieved through the API interface.

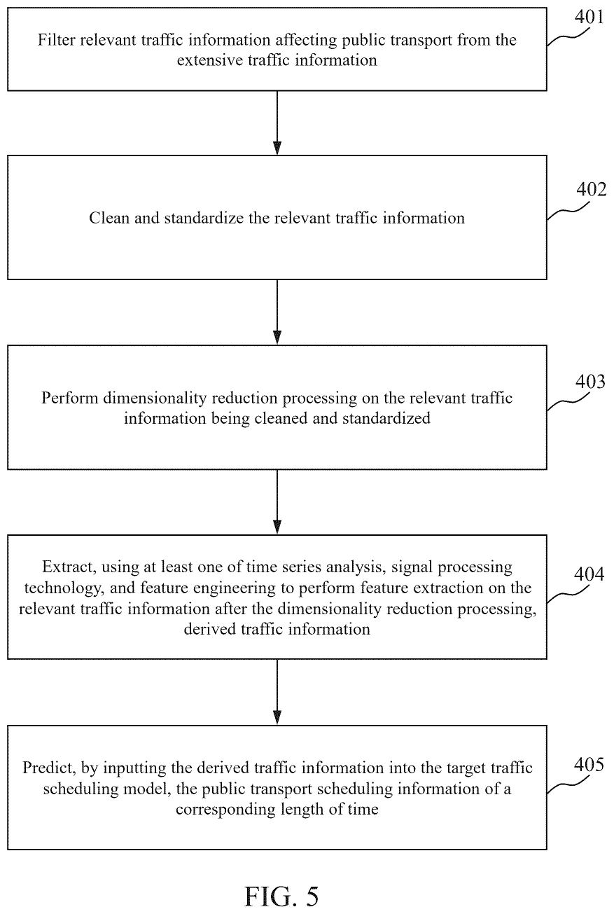

In some embodiments, when the original extensive traffic information is collected, before using the extensive traffic information to train a machine learning model or to predict public transport scheduling information, the original extensive traffic information can be preprocessed to extract useful derived traffic features from the original extensive traffic information, so as to provide more useful input for the traffic scheduling model and effectively support the training and prediction of the traffic scheduling model. Please refer to FIG. 5, which is a schematic diagram of a process for extracting derived traffic features from extensive traffic information provided in an embodiment of the present application. The specific process is as follows:

In 401, filter relevant traffic information affecting public transport from the extensive traffic information;

In 402, clean and standardize the relevant traffic information;

In 403, perform dimensionality reduction processing on the relevant traffic information being cleaned and standardized;

In 404, extract, using at least one of time series analysis, signal processing technology, and feature engineering to perform feature extraction on the relevant traffic information after the dimensionality reduction processing, derived traffic information;

In 405, predict, by inputting the derived traffic information into the target traffic scheduling model, the public transport scheduling information of a corresponding length of time.

By conducting statistical analysis on a large amount of extensive traffic information, relevant traffic information that affects public transport, such as passenger flow and vehicle flow, can be filtered out. The relevant traffic information has a high correlation with public transport. Specifically, statistical analysis methods include correlation analysis, variance analysis, etc., and filtering methods include Pearson correlation coefficient, chi-square test, etc. The relevant traffic information may include, for example, vehicle operating data (such as vehicle location, speed, driving route, arrival time, etc.), passengers'boarding and alighting records, and weather conditions (such as temperature, rainfall, wind speed, etc.), which may affect passengers'travel intention), event information (such as holidays, large-scale events, traffic control, etc., which may have a significant impact on the passenger flow of public transport) and time information (such as date, week, length of time, etc., used to analyze the passenger travel cycle sexual rules). Through filtering, it can be ensured that the data subsequently processed are key information that has a direct or indirect impact on public transport scheduling.

The selected relevant traffic information may contain missing values, abnormal values, repeated values, and variables of different magnitudes. Therefore, the data needs to be cleaned and standardized. For example, outliers can be identified by analyzing the mean, variance, skewness, kurtosis, and other characteristics of the data. The cleaning process is mainly to remove missing values, outliers, and duplicate values. For missing values, interpolation, filling, or deletion can be used for processing; for outliers, statistical methods (such as Z scores, interquartile ranges) can be used to identify and process them; for duplicate values, duplicate values can be removed through inspection. The purpose of standardization is to eliminate the magnitude differences between different variables and to standardize or normalize the data to make them comparable. Standardization, for example, can convert the data into a standard normal distribution with a mean of 0 and a standard deviation of 1, and normalization can scale the data to a preset range, such as [0,1].

Although the data after filtering and cleaning is relatively concise, in order to further improve the training efficiency and prediction accuracy of the model, these data need to be further processed for dimensionality reduction. This step can be achieved through dimensionality reduction techniques, such as principal component analysis (PCA) and linear discriminant analysis (LDA). Dimensionality reduction can extract the feature combination with the largest amount of information from the original features, thereby reducing the feature dimension and reducing the complexity of the model.

For the relevant traffic information after the dimensionality reduction, various methods can be used to extract features to extract useful derived traffic information. For example, time series analysis, signal processing techniques, feature engineering and other methods may be used to further extract and construct derived traffic information that has predictive value for public transport scheduling. Extensive traffic information is generally time series data. Therefore, through time series analysis, the trend and periodicity of passenger demand over time can be revealed. For example, periodic fluctuation characteristics of bus position, speed, and number of passengers can be extracted using methods, such as moving average, difference, and Fourier transform. The signal processing technologies, such as wavelet transform and Fourier transform, can be used to extract frequency domain characteristics of the data and reveal the derived traffic characteristics hidden in passenger behavior patterns. The feature engineering enhances the expressiveness of the model by constructing new features, such as calculating derived traffic features, such as passenger density and flow change rate based on passenger boarding and alighting records.

The derived traffic information after feature extraction, such as trend characteristics of passenger demand, frequency domain characteristics of periodic fluctuations, and passenger behavior patterns, and newly constructed characteristics of passenger density and flow change rate, will be input into the target traffic scheduling model. This information will help the model predict public transport scheduling information within a specific length of time in the future, such as passenger flow, vehicle scheduling demand, and route optimization suggestions. The combined use of these methods can greatly improve the accuracy and comprehensiveness of the feature extraction.

The feature extraction can also be carried out in other various ways. For example, machine learning algorithms and data mining techniques can be used, such as cluster analysis, frequent pattern mining, and other methods to extract features to identify passenger demand patterns, such as identifying passenger demand patterns at different lengths of time and stations, and then extracting derived traffic information based on the identified demand patterns, such as the frequency of rides during peak hours, the number of passengers on specific routes, etc., and then inputting the extracted derived traffic information into the target traffic scheduling model to help the target traffic scheduling model predict the scheduling information of public transport and accurately predict passenger flow in the future.

For example, association rule mining techniques, such as Apriori algorithm, FP-Growth algorithm, etc., may be used for feature extraction to find out whether there is a certain regularity in passengers'riding behaviors under different conditions, and optimize public transport services accordingly.

The association rule mining techniques are used to discover interesting relationships between variables in large datasets, especially frequent co-occurrences between the variables (frequent item sets) and causal relationships between the variables. For example, the Apriori algorithm is one of the most classic association rule mining algorithms. Its core idea is to use the anti-monotonicity of frequent item sets, that is, if an item set is frequent, then all its subsets are also frequent. The specific steps include generating candidate item sets, calculating support, and generating new candidate item sets. Specifically, the generating candidate item sets is to generate candidate item sets from the datasets, and initial candidate item sets are all single items; the calculating support is to calculate the support of each of the candidate item sets, that is, the frequency of the item set in the dataset, and item sets with support higher than a set threshold are retained as the frequent item sets; the generating new candidate item sets is to generate new candidate item sets based on the frequent item sets, and by merging two frequent item sets, a candidate item set containing more items is generated; and the generating new candidate item sets and the calculating support are repeated until new frequent item sets cannot be generated. Through the Apriori algorithm, the passenger riding patterns within a specific length of time can be mined, such as the rule that “a certain website has high demand during the morning rush hour.”

For example, the FP-Growth algorithm is an improvement on the Apriori algorithm, which aims to improve the efficiency of association rule mining. The FP-Growth algorithm represents the dataset by constructing a frequent pattern tree (FP-Tree) and then mines frequent item sets on the FP-Tree. The specific steps include constructing FP-Tree and mining frequent item sets. Constructing FP-Tree is to scan the dataset twice. The first scan calculates the support of each item, and the second scan inserts the item into FP-Tree according to the support. The mining frequent item sets is to perform pattern growth on FP-Tree and recursively mine frequent item sets from the tree. The advantage of the FP-Growth algorithm is that it reduces the number of candidate item set generation and support calculation times, thereby improving mining efficiency. Through the FP-Growth algorithm, more complex ride demand patterns can be discovered, such as the linkage demand of multiple stations in a specific length of time.

The use of association rule mining technology can discover the association rules between passengers'riding behavior and other factors. Based on the association rules, the needs of passengers can be better met. Inputting these identified association rules into the target traffic scheduling model can help the target traffic scheduling model predict public transport scheduling information, so as to realize the intelligent management of the public transport scheduling system, improve operational efficiency, enhance passenger satisfaction, and contribute to the sustainable development of urban transport. For example, based on the identification of peak hours and high-demand stations, departure frequency is adjusted and route configuration is optimized to reduce the waiting time of passengers during high-demand periods and stations, thereby improving riding efficiency. As another example, based on the identified passengers'riding preferences, the route configuration can be optimized to adjust or add direct routes, reduce unnecessary stops, reduce the number of passenger transfers and travel time, enhance the riding experience, and improve route efficiency; as another example, the association rules can be used to predict future changes in demand, and public transport capacity can be flexibly adjusted according to actual demand to ensure that the public transport capacity meets the passenger demand, prevent empty or overloaded situations, and improve resource utilization; as another example, through the reasonable and dynamic allocation of public transport resources, operating costs can be reduced and economic benefits can be improved.

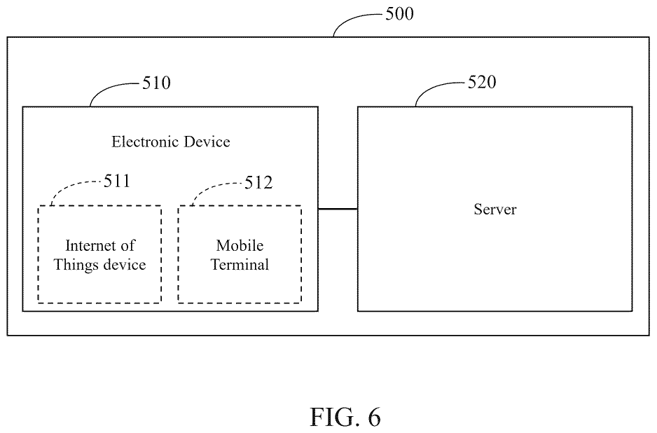

In this embodiment, by deeply understanding the current status of public transport and identifying existing problems and improvement opportunities, such as vehicle punctuality, passenger efficiency, passenger satisfaction, etc., an intelligent public transport scheduling system is proposed to integrate Internet of Things technology, cloud computing, data analysis, and user interaction. Please refer to FIG. 6, which is a structural diagram of the public transport scheduling system provided in the embodiment of this application. The system 500 for public transport scheduling includes an electronic device 510 and a server 520. The electronic device 510 is configured to obtain extensive traffic information. The electronic device 510 includes an Internet of Things device 511 and a mobile terminal 512. The server 520 is connected to the Internet of Things device 511 and the mobile terminal 512. The server 520 is configured to execute the method for public transport scheduling of any of the above embodiments. The mobile terminal 512 may be a mobile terminal, such as a tablet computer or a smart phone, and the server 520 may include a cloud server and/or a local server. The server 520 may be preset with a plurality of traffic scheduling models.

Specifically, the server 520 can execute: obtaining extensive traffic information; determining a target traffic scheduling model from a plurality of traffic scheduling models, and different traffic scheduling models are used to predict public transport scheduling information of different lengths of time; inputting the extensive traffic information into the target traffic scheduling model to predict public transport scheduling information of a corresponding length of time.

In some embodiments, the traffic scheduling model includes a short-term scheduling model, a medium-term scheduling model, and a long-term scheduling model. The short-term scheduling model is used to predict public transport scheduling information of a first length of time, the medium-term scheduling model is used to predict public transport scheduling information of a second length of time, and the long-term scheduling model is used to predict public transport scheduling information of a third length of time. Specifically, the first length of time is less than the second length of time, and the second length of time is less than the third length of time. In determining the target traffic scheduling model from the plurality of traffic scheduling models, the server 520 can execute: determining a length of time for the public transport scheduling information to be predicted; determining, in response to determining that the length of time does not exceed the first length of time, that the short-term scheduling model is the target traffic scheduling model; determining, in response to determining that the length of time exceeds the first length of time but does not exceed the second length of time, that the medium-term scheduling model is the target traffic scheduling model; and determining, in response to determining that the length of time exceeds the second length of time but does not exceed the third length of time, that the long-term scheduling model is the target traffic scheduling model.

In some embodiments, the extensive traffic information includes real-time extensive traffic information and historical extensive traffic information. In determining the length of time of the public transport scheduling information to be predicted, the server 520 can execute: analyzing the real-time extensive traffic information and the historical extensive traffic information to identify fluctuation characteristics of the extensive traffic information, and the fluctuation characteristics include at least one of temporary fluctuation changes, periodic changes, and long-term trends; and according to the length of time that the fluctuation characteristics affect public transport, the length of time of the public transport scheduling information to be predicted is determined.

In some embodiments, if the target traffic scheduling model is determined to be the short-term scheduling model, input the extensive traffic information into the target traffic scheduling model to predict the public transport scheduling information of the corresponding length of time, and the server 520 can execute: obtaining first extensive traffic information corresponding to a fourth length of time; and inputting the first extensive traffic information into the short-term scheduling model to predict first public transport scheduling information of the first length of time.

In some embodiments, if the target traffic scheduling model is determined to be the medium-term scheduling model, input the extensive traffic information into the target traffic scheduling model to predict the public transport scheduling information of a corresponding length of time, and the server 520 can execute: obtaining second extensive traffic information corresponding to a fifth length of time; inputting the second extensive traffic information into the medium-term scheduling model to predict second public transport scheduling information of the second length of time; or inputting the first public transport scheduling information and the second extensive traffic information into the medium-term scheduling model to predict the second public transport scheduling information of the second length of time.

In some embodiments, if the target traffic scheduling model is determined to be the long-term scheduling model, input the extensive traffic information into the target traffic scheduling model to predict the public transport scheduling information of a corresponding length of time, and the server 520 can execute: obtaining third extensive traffic information corresponding to a sixth length of time; inputting the third extensive traffic information into the long-term scheduling model to predict third public transport scheduling information of the third length of time; or inputting the second public transport scheduling information and the third extensive traffic information into the long-term scheduling model to predict the third public transport scheduling information of the third length of time.

In some embodiments, before determining the target traffic scheduling model from the traffic scheduling models, the server 520 can execute: collecting historical extensive traffic information of different lengths of time; and obtaining, using the historical extensive traffic information of each of the lengths of time to perform machine learning, a traffic scheduling model corresponding to each of the lengths of time.

In some embodiments, in performing machine learning using the historical extensive traffic information of each of the lengths of time to obtain the traffic scheduling model corresponding to each of the lengths of time, the server 520 can execute: dividing the historical extensive traffic information of each of the lengths of time into a training dataset, a validation dataset, and a test dataset according to a preset ratio; building, using the training dataset to perform machine learning, an initial traffic scheduling model corresponding to the length of time; optimizing, using the validation dataset to perform a performance evaluation on the initial traffic scheduling model and adjusting parameters of the initial traffic scheduling model according to results of the performance evaluation, the initial traffic scheduling model; evaluating, using the test dataset, generalization performance of the optimized initial traffic scheduling model, and obtaining, in response to that the generalization performance of the optimized initial traffic scheduling model reaches a preset generalization capability requirement, the traffic scheduling model corresponding to the length of time.

In some embodiments, when inputting the extensive traffic information into the target traffic scheduling model to predict the public transport scheduling information of the corresponding length of time, the server 520 can execute: filtering relevant traffic information affecting public transport from the extensive traffic information; cleaning and standardizing the relevant traffic information; performing dimensionality reduction on the relevant traffic information after cleaning and standardization; performing feature extraction on the relevant traffic information after dimensionality reduction using at least one of time series analysis, signal processing technology, and feature engineering to extract derived traffic information; and inputting the derived traffic information into the target traffic scheduling model to predict public transport scheduling information of the corresponding length of time.

Exemplarily, the deployment of the system 500 for public transport scheduling is described below. When deploying the system 500 for public transport scheduling, the present embodiment selects and deploys the Internet of Things device 511, such as deploying the Internet of Things device 511 on a bus, a bus stop, or other transportation facilities. The Internet of Things device 511 may include, for example, a GPS tracker, a passenger counter, an environmental sensor, etc., which can be used to collect vehicle information, passenger information, environmental information, etc., including the real-time location, speed, passenger capacity and other operating information of the vehicle, the number of passengers boarding and alighting at each stop, the waiting status of passengers at the bus stop, and weather conditions, etc. The extensive information collection provides a comprehensive real-time perspective for the system 500 for public transport scheduling, and uploads this information to the server 520.

In order to enable passengers to directly interact with the system 500 for public transport dispatch, a user-friendly application can be developed on the mobile terminal 512, such as a smart phone, through which passengers can input their travel needs in advance, including the boarding location, destination, and estimated time. This information is uploaded to the server 520 via the application, providing the server 520 with richer data support for accurate scheduling prediction. In addition, passengers can also check the arrival time of the vehicle or evaluate the service quality through the application. The use of the application helps to collect various kinds of data related to the passengers and increases the interactivity between the passengers and the system 500 for public transport scheduling, allowing passengers to easily participate in the optimization process of public transport services.

The system 500 for public transport scheduling of this embodiment further builds the powerful server 520, which can be a cloud server. Specifically, various kinds of extensive traffic information collected by the IoT device 511 and applications can be uploaded to the server 520. For example, various kinds of collected information is transmitted from the applications of the IoT device 511 and the mobile terminal 512 to the server 520 in real time through a secure and efficient communication protocol (such as MQTT, HTTP). A database can be established on the server 520 to store this large amount of information. This embodiment does not limit the type of database, as long as the database has high availability and scalability and can cope with the storage needs of large-scale data. For example, it can be a relational database (such as MySQL), a non-relational database (such as MongoDB), etc. Of course, the server 520 may also obtain extensive traffic information in other ways, such as regularly collecting information from authoritative media and official websites.

The server 520 is not only a data storage center, but also the brain for data analysis and processing. The server 520 is integrated with advanced machine learning and artificial intelligence algorithms, and can predict public transport scheduling information for a period of time in the future based on the collected extensive traffic information through a preset traffic scheduling model. The server 520 may send the predicted public transport scheduling information to the traffic management department, and the traffic management department may perform transport scheduling based on the predicted public transport scheduling information, such as optimization of departure frequency, driving routes, and stop sites.

After the initial deployment of the system 500 for public transport scheduling, testing will be carried out, including unit testing, integration testing, and system testing. Necessary adjustments and optimizations will be made based on the test results to ensure the stability and performance of each component and the overall system.

In addition, public transport drivers will also be trained to familiarize them with the operation of the public transport scheduling system 500 to ensure that they can use the public transport scheduling system 500 smoothly. At the same time, publicity and education activities are used to improve passengers'awareness of and willingness to use the public transport scheduling system 500. Exemplarily, based on the public transport scheduling system 500 of this embodiment, after the server 520 collects extensive traffic information, it can transmit information useful to the driver to the in-vehicle equipment of the vehicle approaching the platform in real time, so that the driver can obtain the number of passengers waiting on the platform and destination information through in-vehicle equipment before arriving at the platform, so that they can flexibly adjust their driving plans and stop times to better meet passenger needs and improve service responsiveness. For example, the driver optimizes the stop time and speed according to real-time passenger data, reduces unnecessary waiting and empty driving, provides more punctual service, improves overall transportation efficiency, improves passenger satisfaction, and realizes a more efficient, more environmentally friendly, and more passenger-friendly public transport system.

After ensuring that the system 500 for public transport scheduling operates stably and all functions achieve the expected results, a complete deployment is carried out. At the same time, a monitoring and maintenance mechanism for the system 500 for public transport scheduling is established to monitor the operation status of public transport and changes in passenger demand in real time, and to promptly discover and solve problems to ensure the long-term stable operation of the system 500 for public transport scheduling. Moreover, the system 500 for public transport scheduling of this embodiment will continue to be improved and optimized, and can continuously perform data analysis and system optimization based on the operation of the system 500 for public transport scheduling and the feedback from passengers and drivers to adapt to changes in the passenger demand and technological development.

Through this series of closely connected and integrated steps, it is aimed to realize an efficient, flexible, and user-friendly intelligent system 500 for public transport scheduling, which not only improves operational efficiency and passenger satisfaction, but also contributes to the sustainable development of urban transportation. With the continuous advancement of technologies and the enhancement of data analysis capabilities, the accuracy and efficiency of the system will be further improved, providing strong technical support and innovative impetus for the future development of public transport systems.

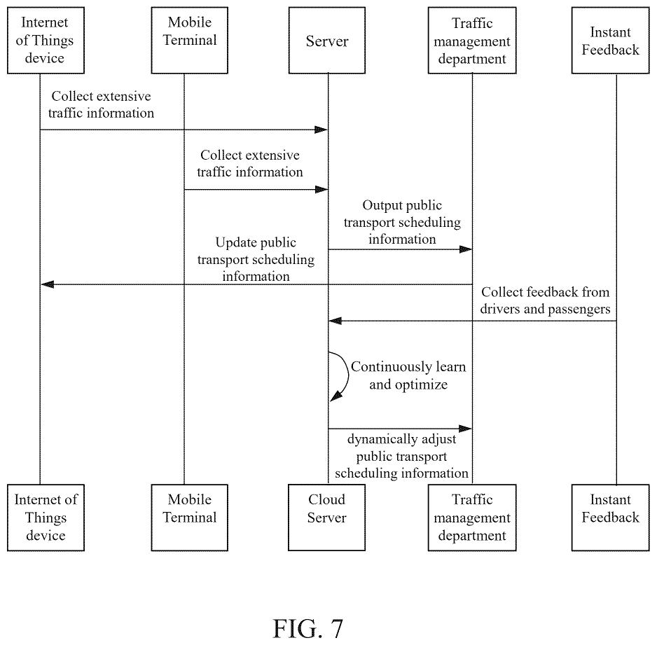

Please refer to FIG. 7, which is a schematic diagram of a scenario of the operation of the system for public transport scheduling in an embodiment of the present application.

The system for public transport scheduling of this embodiment is an intelligent public transport scheduling system 500 that combines Internet of Things technology, mobile terminal applications, and cloud data analysis, aiming to improve the efficiency of public transport and passenger satisfaction.

The system 500 for public transport scheduling of this embodiment can collect various kinds of extensive traffic scheduling information in real time through the application of the Internet of Things device 511 and the mobile terminal 512, such as vehicle information, passenger information, environmental information, etc. For example, the Internet of Things device 511 in the vehicle or station can collect data such as vehicle location, speed, passenger capacity, and passenger waiting status in real time. Passengers input their riding demands in advance through the application, including information such as boarding location, destination, and estimated boarding time, and upload the collected data to the server 520.

The server 520 is a cloud platform that can store, process and analyze massive amounts of data. The server 520 is integrated with a machine learning algorithm, and based on the acquired extensive traffic scheduling information, it can output the public transport scheduling information by using the method for public transport scheduling of any of the above embodiments. The traffic management department can optimize the scheduling of public transport in real time based on the public transport scheduling information provided by the server 520, such as adjusting the vehicle departure frequency, planning the best driving route, and stop points, etc. The public transport scheduling information can also be updated to the Internet of Things device 511, so that the Internet of Things device 511 can receive the updated scheduling information in real time, and can provide passengers with real-time public transport information, such as vehicle arrival time, route changes, etc., to enhance the travel experience of passengers.

The system for public transport scheduling also provides an instant feedback mechanism to collect real-time feedback from drivers and passengers, such as drivers reporting on passengers boarding and alighting the bus, and passengers evaluating their riding experience and sending real-time feedback to the server 520. Specifically, passengers and drivers may submit their feedback via an application on the mobile terminal 512 or the IoT device 511, and the feedback may be transmitted to the server 520.

The machine learning algorithm integrated in the server 520 can continuously learn and optimize based on the collected data and the real-time feedback to improve the accuracy of predictions, thereby ensuring that the system 500 for public transport scheduling can dynamically adjust public transport scheduling information in real time and accurately to adapt to changes in demand.

Through the implementation of the system 500 for public transport scheduling of this embodiment, the public transport scheduling system is transformed from a relatively static mode that relies on manual dispatching to a highly dynamic, data-driven service system. This transformation will bring many advantages such as convenience, efficiency, improved passenger satisfaction, adaptability, and flexibility, and sustainable development, injecting new vitality and impetus into the future development of urban transportation systems. This transformation will bring significant advantages in the following aspects:

In terms of passengers, this embodiment significantly improves the efficiency and flexibility of public transport scheduling, such as bus scheduling by collecting and analyzing passenger riding demands in real time, reducing passenger waiting time, and meeting passenger demand more accurately, thereby significantly improving passenger satisfaction.

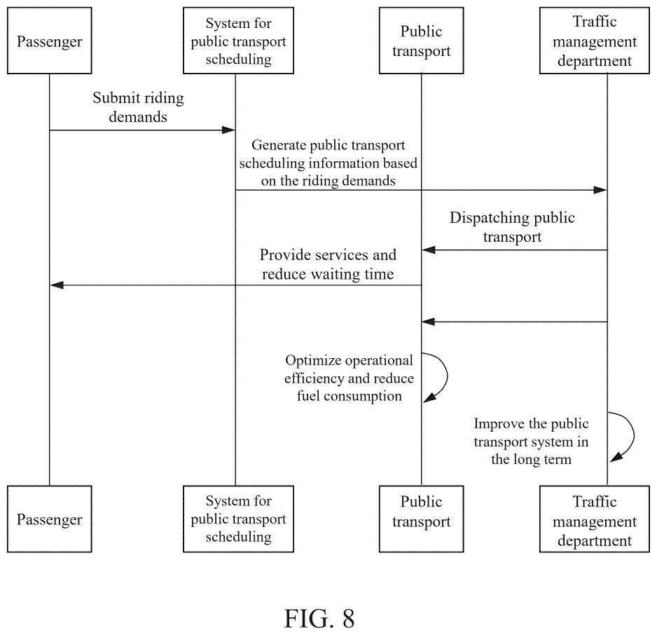

For example, please refer to FIG. 8, which is a schematic diagram of another scenario of the operation of the system for public transport scheduling provided in an embodiment of the present application. Passengers submit their riding demands to the system 500 for public transport scheduling through the application of the mobile terminal 512 or the interactive interface of the Internet of Things device 511. The riding demands include information such as the boarding location, destination, and estimated boarding time. After receiving the passengers'riding demands, the system 500 for public transport scheduling analyzes them in combination with other data sources (such as the real-time location, speed, and passenger capacity of the bus), selects a suitable traffic scheduling model, predicts future passenger flow based on the passenger demand and traffic conditions, and generates corresponding public transport scheduling information. The traffic management department based on the public transport scheduling information predicted by the system 500 for public transport scheduling can perform actual public transport scheduling, such as vehicle dispatching, adjusting the vehicle departure frequency, planning the driving route, and selecting the stop sites. According to the instructions of the traffic management department, vehicle drivers implement a scheduling plan and go to various stations to pick up and drop off passengers. By optimizing vehicle scheduling, passengers'waiting time can be shortened, fuel consumption can be reduced, and faster bus services can be provided. In addition, the system 500 for public transport scheduling can continuously improve the prediction algorithm and scheduling scheme based on the data and feedback collected over a long period of time, so that the traffic management department can respond to the current passenger demand in a timely manner based on more accurate predictions and improve the public transport system in the long term.

In terms of drivers, according to a public transport scheduling plan, drivers'working hours and driving routes are reasonably arranged to ensure the drivers'working hours, thereby preventing drivers from being overworked or idle, and ensuring the quality of service. In addition, before arriving at a platform, the drivers can obtain the number of passengers waiting at the platform and their destination information through in-vehicle equipment or other equipment. The drivers can flexibly adjust their driving plans and stop times to better meet the passenger demand and improve service responsiveness.

In terms of alleviating urban traffic congestion, this embodiment can achieve more effective public transport scheduling, such as shortening the departure interval and increasing the frequency of trips during peak hours to cope with high demand; extending the departure interval and reducing the frequency of trips during non-peak hours to reduce operating costs, effectively reducing traffic pressure on major roads and improving the overall smoothness of urban traffic.

In terms of environmental protection, this embodiment further reduces fuel consumption and greenhouse gas emissions by optimizing the operating efficiency of public transport vehicles such as buses. Vehicles can be precisely dispatched according to actual needs, thus preventing unnecessary empty loads and overloading, and achieving a more environmentally friendly public transport service.

In addition, the system for public transport scheduling of this embodiment has powerful data-driven decision-making capabilities. By collecting and analyzing large amounts of passenger data, the traffic management department can gain a deeper understanding of passenger behavior and demand patterns, thereby providing a scientific basis and strong support for long-term transport planning and improvements.

Accordingly, the present application not only significantly improves the transportation efficiency and passenger satisfaction of public transport such as buses, but also has a positive impact on urban traffic congestion, environmental protection, and transport planning. It is an innovative technology with broad application prospects and significant social benefits, and is expected to play a more important role in the future public transport system.

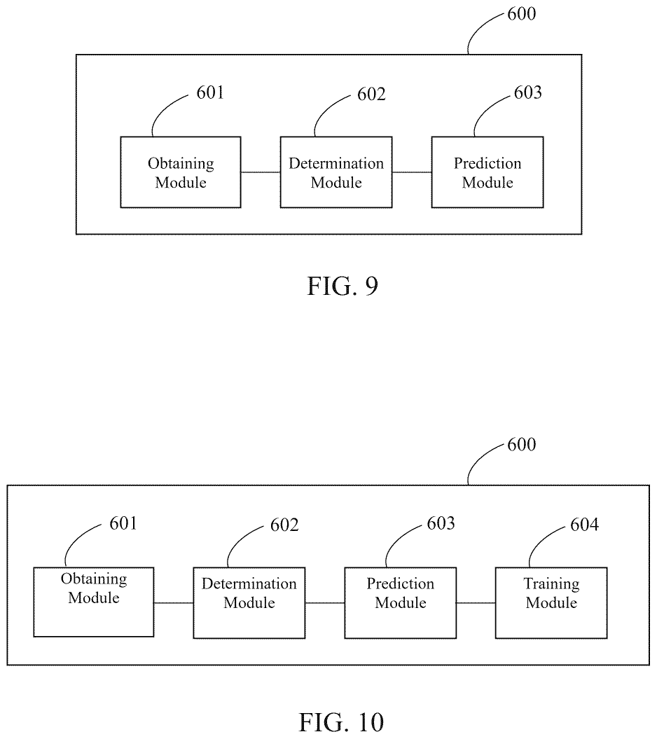

Please refer to FIGS. 9 and 10. FIG. 9 is a schematic structural diagram of a device for public transport scheduling provided in an embodiment of the present application, and FIG. 10 is another schematic structural diagram of a device for public transport scheduling provided in an embodiment of the present application. A device 600 for public transport scheduling may include an obtaining module 601, a determination module 602, and a prediction module 603.

The obtaining module 601 is configured to: obtain extensive traffic information, where the extensive traffic information includes at least one of vehicle information, passenger information, environmental information, time information, and event information;

The determination module 602 is configured to: determine a target traffic scheduling model from a plurality of traffic scheduling models, where different traffic scheduling models are used to predict public transport scheduling information of different lengths of time;

The prediction module 603 is configured to input the extensive traffic information into the target traffic scheduling model to predict the public transport scheduling information of a corresponding length of time.

In some embodiments, the traffic scheduling model includes a short-term scheduling model, a medium-term scheduling model, and a long-term scheduling model. The short-term scheduling model is used to predict public transport scheduling information of a first length of time, the medium-term scheduling model is used to predict public transport scheduling information of a second length of time, and the long-term scheduling model is used to predict public transport scheduling information of a third length of time. Specifically, the first length of time is less than the second length of time, and the second length of time is less than the third length of time. The determination module 602 can be used to: determine a length of time of the public transport scheduling information to be predicted; determine, in response to determining that the length of time does not exceed the first length of time, that the short-term scheduling model is the target traffic scheduling model; determine, in response to determining that the length of time exceeds the first length of time but does not exceed the second length of time, that the medium-term scheduling model is the target traffic scheduling model; and determine, in response to determining that the length of time exceeds the second length of time but does not exceed the third length of time, that the long-term scheduling model is the target traffic scheduling model.

In some embodiments, the extensive traffic information includes real-time extensive traffic information and historical extensive traffic information, and the determination module 602 can be used to: analyze the real-time extensive traffic information and the historical extensive traffic information to identify the fluctuation characteristics of the extensive traffic information, and the fluctuation characteristics include at least one of temporary fluctuation changes, periodic changes, and long-term trends; and according to the length of time that the fluctuation characteristics affect public transport, determine the length of time of the public transport scheduling information to be predicted.

In some embodiments, if the target traffic scheduling model is determined to be the short-term scheduling model, the prediction module 603 can be used to: obtain first extensive traffic information corresponding to a fourth length of time; input the first extensive traffic information into the short-term scheduling model to predict first public transport scheduling information of the next first length of time.

In some embodiments, if the target traffic scheduling model is determined to be the medium-term scheduling model, the prediction module 603 can be used to: obtain second extensive traffic information corresponding to a fifth length of time; input the second extensive traffic information into the medium-term scheduling model to predict the second public transport scheduling information within the next second length of time; or input the first public transport scheduling information and the second extensive traffic information into the medium-term scheduling model to predict the second public transport scheduling information for the next second length of time.

In some embodiments, if the target traffic scheduling model is determined to be the long-term scheduling model, the prediction module 603 can be used to: obtain third extensive traffic information corresponding to a sixth length of time; input the third extensive traffic information into the long-term scheduling model to predict the third public transport scheduling information for the next third length of time; or input the second public transport scheduling information and the third extensive traffic information into the long-term scheduling model to predict the third public transport scheduling information for the next third length of time.

In some embodiments, the public transport scheduling device 600 further includes a training module 604, which can be used to: collect historical extensive traffic information of a plurality of different lengths of time; perform machine learning on the historical extensive traffic information of each of the lengths of time to obtain a traffic scheduling model corresponding to each of the lengths of time.

In some embodiments, the training module 604 can be used to: divide the historical extensive traffic information of each of the lengths of time into a training dataset, a validation dataset, and a test dataset according to a preset ratio; build, using the training dataset to perform machine learning on the machine learning model, an initial traffic scheduling model corresponding to the length of time; optimize, using the validation dataset to perform a performance evaluation on the initial traffic scheduling model and adjusting parameters of the initial traffic scheduling model according to results of the performance evaluation, the initial traffic scheduling model; evaluate, using the test dataset, generalization performance of the optimized initial traffic scheduling model, and obtain, in response to that the generalization performance of the optimized initial traffic scheduling model reaches a preset generalization capability requirement, the traffic scheduling model corresponding to the length of time.

In some embodiments, the prediction module 603 can be used to: filter relevant traffic information affecting public transport from the extensive traffic information; clean and standardize the relevant traffic information; perform dimensionality reduction on the relevant traffic information after cleaning and standardization; perform feature extraction on the relevant traffic information after dimensionality reduction using at least one of time series analysis, signal processing technology, and feature engineering to extract derived traffic information; and input the derived traffic information into the target traffic scheduling model to predict public transport scheduling information of the corresponding length of time.

An embodiment of the present application provides a computer-readable storage medium having a computer program stored thereon. When the computer program is executed on a computer, the computer executes the process in the method for public transport scheduling provided in the present embodiment.

In the above embodiments, the description of each embodiment has its own focus. For the part that is not described in detail in a certain embodiment, please refer to the detailed description of the method for public transport scheduling above, which will not be repeated here.

The device for public transport scheduling provided in the embodiment of the present application belongs to the same concept as the method for public transport scheduling in the above embodiments. Any method provided in the embodiments of the method for public transport scheduling can be run on the device for public transport scheduling, and its specific implementation process is detailed in the embodiments of the method for public transport scheduling, which will not be repeated here. For the device for public transport scheduling in the embodiments of the present application, its various functional modules may be integrated into one processing chip, or each module may exist physically separately, or two or more modules may be integrated into one module. The above integrated modules can be implemented in the form of hardware or in the form of software function modules. If the integrated module is implemented in the form of a software function module and sold or used as an independent product, it can also be stored in a computer-readable storage medium, such as a read-only memory, a disk, or an optical disk.

It should be noted that, with respect to the method for public transport scheduling in the embodiments of the present application, a person of ordinary skill in the art can understand that all or part of the process of implementing the method for public transport scheduling in the embodiments of the present application can be completed by controlling related hardware through a computer program, and the computer program can be stored in a computer-readable storage medium, such as in a memory, and executed by at least one processor, and during the execution process, it may include the process of the embodiments of the method for public transport scheduling. Specifically, the storage medium may be magnetic disks, optical disks, read-only memories (ROMs), random access memories (RAMs), etc.

The above is a detailed introduction to the method, device, storage medium, and mobile terminal for public transport scheduling provided in the embodiments of the present application. Specific examples are used in this article to illustrate the principles and implementation methods of the present application. The description of the above embodiments is only used to help understand the method of the present application and its core idea; at the same time, for technical personnel in this field, according to the ideas of the present application, there will be changes in the specific implementation methods and application scopes. Accordingly, the content of this specification should not be understood as a limitation on the present application.

What is claimed is:

1. A method for public transport scheduling, the method comprising:
obtaining extensive traffic information;
determining a target traffic scheduling model from a plurality of different traffic scheduling models, wherein the different traffic scheduling models are used to predict public transport scheduling information of different lengths of time; and
inputting the extensive traffic information into the target traffic scheduling model to predict the public transport scheduling information of a corresponding length of time.

2. The method for public transport scheduling of claim 1, wherein the traffic scheduling models comprise a short-term scheduling model, a medium-term scheduling model, and a long-term scheduling model, wherein the short-term scheduling model is used to predict the public transport scheduling information within a first length of time, the medium-term scheduling model is used to predict the public transport scheduling information within a second length of time, and the long-term scheduling model is used to predict the public transport scheduling information within a third length of time, wherein the first length of time is shorter than the second length of time, the second length of time is shorter than the third length of time, and the determining a target traffic scheduling model from a plurality of traffic scheduling models comprises:
determining a length of time for the public transport scheduling information to be predicted;
determining, in response to determining that the length of time does not exceed the first length of time, that the short-term scheduling model is the target traffic scheduling model;
determining, in response to determining that the length of time exceeds the first length of time but does not exceed the second length of time, that the medium-term scheduling model is the target traffic scheduling model;
determining, in response to determining that the length of time exceeds the second length of time but does not exceed the third length of time, that the long-term scheduling model is the target traffic scheduling model.

3. The method for public transport scheduling of claim 2, wherein in response to determining that the target traffic scheduling model is the short-term scheduling model, the inputting the extensive traffic information into the target traffic scheduling model to predict the public transport scheduling information of a corresponding length of time comprises:
obtaining first extensive traffic information corresponding to a fourth length of time; and
inputting the first extensive traffic information into the short-term scheduling model to predict first public transport scheduling information of the first length of time.

4. The method for public transport scheduling of claim 3, wherein in response to determining that the target traffic scheduling model is the medium-term scheduling model, the inputting the extensive traffic information into the target traffic scheduling model to predict the public transport scheduling information of a corresponding length of time comprises:
obtaining second extensive traffic information corresponding to a fifth length of time, wherein the fifth length of time is greater than the fourth length of time;
inputting the second extensive traffic information into the medium-term scheduling model to predict second public transport scheduling information of the second length of time; or
inputting the first public transport scheduling information and the second extensive traffic information into the medium-term scheduling model to predict the second public transport scheduling information of the second length of time.

5. The method for public transport scheduling of claim 4, wherein in response to determining that the target traffic scheduling model is the long-term scheduling model, the inputting the extensive traffic information into the target traffic scheduling model to predict the public transport scheduling information of a corresponding length of time comprises:
obtaining third extensive traffic information corresponding to a sixth length of time, wherein the sixth length of time is greater than the fifth length of time;
inputting the third extensive traffic information into the long-term scheduling model to predict third public transport scheduling information of the third length of time; or
inputting the second public transport scheduling information and the third extensive traffic information into the long-term scheduling model to predict the third public transport scheduling information of the third length of time.

6. The method for public transport scheduling of claim 2, wherein the extensive traffic information comprises real-time extensive traffic information and historical extensive traffic information, and the determining a length of time for the public transport scheduling information to be predicted comprises:
analyzing the real-time extensive traffic information and the historical extensive traffic information to identify fluctuation characteristics of the extensive traffic information, wherein the fluctuation characteristics comprise at least one of temporary fluctuation changes, periodic changes, and long-term trends; and
determining the length of time for the public transport scheduling information to be predicted according to a duration of the impact of the fluctuation characteristics on the public transport.

7. The method for public transport scheduling of claim 1, wherein prior to the determining a target traffic scheduling model from a plurality of different traffic scheduling models, the method further comprises:
collecting historical extensive traffic information of different lengths of time; and
obtaining, using the historical extensive traffic information of each of the lengths of time to perform machine learning, a traffic scheduling model corresponding to each of the lengths of time.

8. The method for public transport scheduling of claim 7, wherein the obtaining, using the historical extensive traffic information of each of the lengths of time to perform machine learning, a traffic scheduling model corresponding to each of the lengths of time comprises:
dividing the historical extensive traffic information of each of the lengths of time into a training dataset, a validation dataset, and a test dataset according to a preset ratio;
building, using the training dataset to perform machine learning, an initial traffic scheduling model corresponding to the length of time;
optimizing, using the validation dataset to perform a performance evaluation on the initial traffic scheduling model and adjusting parameters of the initial traffic scheduling model according to results of the performance evaluation, the initial traffic scheduling model; and
evaluating, using the test dataset, generalization performance of the optimized initial traffic scheduling model, and obtaining, in response to that the generalization performance of the optimized initial traffic scheduling model reaches a preset generalization capability requirement, the traffic scheduling model corresponding to the length of time.

9. The method for public transport scheduling of claim 1, wherein the inputting the extensive traffic information into the target traffic scheduling model to predict the public transport scheduling information of a corresponding length of time comprises:
filtering relevant traffic information affecting public transport from the extensive traffic information;
cleaning and standardizing the relevant traffic information;
performing dimensionality reduction processing on the relevant traffic information being cleaned and standardized;
extracting, using at least one of time series analysis, signal processing technology, and feature engineering to perform feature extraction on the relevant traffic information after the dimensionality reduction processing, derived traffic information; and
predicting, by inputting the derived traffic information into the target traffic scheduling model, the public transport scheduling information of a corresponding length of time.

10. A system for public transport scheduling, the system comprising:
an electronic device obtaining extensive traffic information and comprising a mobile terminal and an Internet of Things device; and
a server connected to the Internet of Things device and the mobile terminal and configured to execute a method for public transport scheduling;
wherein the method comprises:
obtaining extensive traffic information;
determining a target traffic scheduling model from a plurality of different traffic scheduling models, wherein the different traffic scheduling models are used to predict public transport scheduling information of different lengths of time; and
inputting the extensive traffic information into the target traffic scheduling model to predict the public transport scheduling information of a corresponding length of time.

11. The system for public transport scheduling of claim 10, wherein the traffic scheduling models comprise a short-term scheduling model, a medium-term scheduling model, and a long-term scheduling model, wherein the short-term scheduling model is used to predict the public transport scheduling information within a first length of time, the medium-term scheduling model is used to predict the public transport scheduling information within a second length of time, and the long-term scheduling model is used to predict the public transport scheduling information within a third length of time, wherein the first length of time is shorter than the second length of time, the second length of time is shorter than the third length of time, and the step of determining a target traffic scheduling model from a plurality of traffic scheduling models comprises:
determining a length of time for the public transport scheduling information to be predicted;
determining, in response to determining that the length of time does not exceed the first length of time, that the short-term scheduling model is the target traffic scheduling model;
determining, in response to determining that the length of time exceeds the first length of time but does not exceed the second length of time, that the medium-term scheduling model is the target traffic scheduling model;
determining, in response to determining that the length of time exceeds the second length of time but does not exceed the third length of time, that the long-term scheduling model is the target traffic scheduling model.

12. The system for public transport scheduling of claim 11, wherein in response to determining that the target traffic scheduling model is the short-term scheduling model, the inputting the extensive traffic information into the target traffic scheduling model to predict the public transport scheduling information of a corresponding length of time comprises:
obtaining first extensive traffic information corresponding to a fourth length of time; and
inputting the first extensive traffic information into the short-term scheduling model to predict first public transport scheduling information of the first length of time.

13. The system for public transport scheduling of claim 12, wherein in response to determining that the target traffic scheduling model is the medium-term scheduling model, the inputting the extensive traffic information into the target traffic scheduling model to predict the public transport scheduling information of a corresponding length of time comprises:
obtaining second extensive traffic information corresponding to a fifth length of time, wherein the fifth length of time is greater than the fourth length of time;
inputting the second extensive traffic information into the medium-term scheduling model to predict second public transport scheduling information of the second length of time; or
inputting the first public transport scheduling information and the second extensive traffic information into the medium-term scheduling model to predict the second public transport scheduling information of the second length of time.

14. The system for public transport scheduling of claim 13, wherein in response to determining that the target traffic scheduling model is the long-term scheduling model, the inputting the extensive traffic information into the target traffic scheduling model to predict the public transport scheduling information of a corresponding length of time comprises:
obtaining third extensive traffic information corresponding to a sixth length of time, wherein the sixth length of time is greater than the fifth length of time;
inputting the third extensive traffic information into the long-term scheduling model to predict third public transport scheduling information of the third length of time; or
inputting the second public transport scheduling information and the third extensive traffic information into the long-term scheduling model to predict the third public transport scheduling information of the third length of time.

15. The system for public transport scheduling of claim 11, wherein the extensive traffic information comprises real-time extensive traffic information and historical extensive traffic information, and the determining a length of time for the public transport scheduling information to be predicted comprises:
analyzing the real-time extensive traffic information and the historical extensive traffic information to identify fluctuation characteristics of the extensive traffic information, wherein the fluctuation characteristics comprise at least one of temporary fluctuation changes, periodic changes, and long-term trends; and
determining the length of time for the public transport scheduling information to be predicted according to a duration of the impact of the fluctuation characteristics on the public transport.

16. The system for public transport scheduling of claim 10, wherein prior to the determining a target traffic scheduling model from a plurality of different traffic scheduling models, the method further comprises:
collecting historical extensive traffic information of different lengths of time; and
obtaining, using the historical extensive traffic information of each of the lengths of time to perform machine learning, a traffic scheduling model corresponding to each of the lengths of time.

17. The system for public transport scheduling of claim 16, wherein the obtaining, using the historical extensive traffic information of each of the lengths of time to perform machine learning, a traffic scheduling model corresponding to each of the lengths of time comprises:
dividing the historical extensive traffic information of each of the lengths of time into a training dataset, a validation dataset, and a test dataset according to a preset ratio;
building, using the training dataset to perform machine learning, an initial traffic scheduling model corresponding to the length of time;
optimizing, using the validation dataset to perform a performance evaluation on the initial traffic scheduling model and adjusting parameters of the initial traffic scheduling model according to results of the performance evaluation, the initial traffic scheduling model; and
evaluating, using the test dataset, generalization performance of the optimized initial traffic scheduling model, and obtaining, in response to that the generalization performance of the optimized initial traffic scheduling model reaches a preset generalization capability requirement, the traffic scheduling model corresponding to the length of time.

18. The system for public transport scheduling of claim 10, wherein the inputting the extensive traffic information into the target traffic scheduling model to predict the public transport scheduling information of a corresponding length of time comprises:
filtering relevant traffic information affecting public transport from the extensive traffic information;
cleaning and standardizing the relevant traffic information;
performing dimensionality reduction processing on the relevant traffic information being cleaned and standardized;
extracting, using at least one of time series analysis, signal processing technology, and feature engineering to perform feature extraction on the relevant traffic information after the dimensionality reduction processing, derived traffic information; and
predicting, by inputting the derived traffic information into the target traffic scheduling model, the public transport scheduling information of a corresponding length of time.

19. The system for public transport scheduling of claim 10, further comprising a storage medium storing a computer program, wherein when the computer program is run on a computer, the computer is enabled to execute the method for public transport scheduling.

20. A device for public transport scheduling, the device comprising at least one memory configured to store program instructions;
and at least one processor configured to execute the program instructions, which cause the at least one processor to:
obtain extensive traffic information;
determine a target traffic scheduling model from a plurality of different traffic scheduling models, wherein the different traffic scheduling models are used to predict public transport scheduling information of different lengths of time; and
input the extensive traffic information into the target traffic scheduling model to predict the public transport scheduling information of a corresponding length of time.
